(19) United States
(12) Patent Application Publication
(10) Pub. No.: US 2026/0319802 A1
(43) Pub. Date: Oct. 15, 2026

(54) ADDRESS REMAPPING METHOD, HARDWARE ONLINE UPGRADE METHOD, CIRCUIT, DEVICE, AND SYSTEM

(71) Applicant: Silergy Semiconductor Technology (Hangzhou) LTD, Hangzhou (CN)

(72) Inventors: Xiaozhi Zou, Hangzhou (CN); Shunhua He, Hangzhou (CN); Wenyu Zhao, Hangzhou (CN)

(21) Appl. No.: 19/561,840

(22) Filed: Mar. 10, 2026

(30) Foreign Application Priority Data
Apr. 11, 2025 (CN) 202510460080.7

(51) Int. Cl. G06F 9/355; G06F 9/26

(52) U.S. Cl. CPC G06F 9/355; G06F 9/268

(57) ABSTRACT

An address remapping circuit can include: a logic judgment circuit configured to determine whether a current instruction address of a microprocessor points to an interrupt vector table of an initial program code area; an address offset circuit configured to, in response to the current instruction address pointing to the interrupt vector table of the initial program code area, perform address offset on the current instruction address according to a target offset address, where the target offset address is a start address of a target program code area; and a readout circuit configured to read a target reset vector from a code memory according to the offset instruction address.

### RELATED APPLICATIONS

This application claims the benefit of Chinese Patent Application No. 202510460080.7, filed on Apr. 11, 2025, which is incorporated herein by reference in its entirety.

### FIELD OF THE INVENTION

The present invention generally relates to the field of controllers and addressing, and more particularly to address remapping methods, hardware online upgrade methods, circuits, devices, and systems.

### BACKGROUND

As microcontroller units (MCUs) carry increasingly complex functions, hardware online upgrade (e.g., Firmware Over-The-Air [FOTA]) has become a necessary item among the many functions of MCUs. Hardware online upgrade can support MCUs in upgrading their own application software versions via online means without returning to the factory. Currently, hardware online upgrade is typically implemented by MCUs through deploying and operating a multi-program code area storage architecture. However, the deployment and operation of a multi-program code area storage architecture often require the MCU itself to possess program code area jump capability, which can make some MCUs that lack this capability themselves unable to deploy and operate the multi-program code area storage architecture, thereby preventing these MCUs from achieving hardware online upgrade.

### BRIEF DESCRIPTION OF THE DRAWINGS

FIG. 1 is a schematic diagram of an example hardware online upgrade system, in accordance with embodiments of the present invention.

FIG. 2 is a schematic diagram of an example code memory, in accordance with embodiments of the present invention.

FIG. 3 is a flowchart of an example address remapping method, in accordance with embodiments of the present invention.

FIG. 4 is a schematic diagram of an example offset address output circuit, in accordance with embodiments of the present invention.

FIG. 5 is a schematic diagram of an example address remapping circuit, in accordance with embodiments of the present invention.

FIG. 6 is a flowchart of an example hardware online upgrade method, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Further, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Deploying a multi-program code area storage architecture may, e.g., refer to dividing a code memory into a plurality of program code storage areas and storing program codes of different programs in the plurality of program code storage areas, respectively. During a hardware online upgrade process, the existence of a multi-program code area storage architecture can ensure that a microprocessor can achieve version upgrade of a main program by switching to run other programs. In particular embodiments, the multi-program code area storage architecture may include at least one application program code area and a bootloader program code area. The application program code area can store program code of an application program. The application program can be a main program of the microprocessor, which can be executed by the microprocessor to enable the microprocessor to implement corresponding business logic, thereby providing services or functions externally. The bootloader program code area can store program code of a bootloader program. The bootloader program can be an auxiliary program of the microprocessor, which can be executed by the microprocessor to enable the microprocessor to perform hardware initialization upon system power-up, and perform operations such as downloading new version application programs, verification, and replacement of old version application programs during a hardware online upgrade process.

In some applications, depending on the number of application program code areas set, particular embodiments may adopt different hardware upgrade methods. For example, when the number of application program code areas is unique, the unique application program code area can store the current latest version of the application program code. In this scenario, when the microprocessor jumps to the bootloader program code area and performs hardware online upgrade by running the bootloader program, it can download and verify an upgrade package of a new version application program, and directly replace the old version application program code stored in the application program code area with the new version application program code according to the upgrade package. In another example, when the number of application program code areas is multiple, the multiple application program code areas can store application program codes of different versions, respectively. In this scenario, when the microprocessor jumps to the bootloader program code area and performs hardware online upgrade by running the bootloader program, it can download and verify an upgrade package of a new version application program, and store the new version application program code in a corresponding application program code area according to the upgrade package, while avoiding overwriting the old version application program code. In some applications, specific hardware upgrade methods can be set and adjusted by relevant personnel according to actual situations (e.g., whether the storage space of the code memory supports it, system reliability requirements, and user hardware upgrade flexibility needs, etc.).

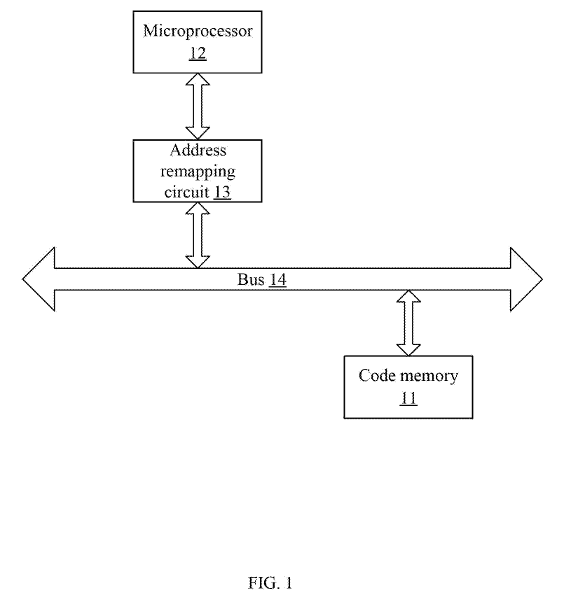

Referring now to FIG. 1, shown is a schematic diagram of an example hardware online upgrade system, in accordance with embodiments of the present invention. In this particular example, the hardware online upgrade system can include code memory 11, microprocessor 12, and address remapping circuit 13. Code memory 11 is a storage unit capable of storing code data. In particular embodiments, the internal storage area of code memory 11 can be divided into a bootloader program code area and at least one application program code area. Optionally, code memory 11 can be any type of non-volatile memory, such as flash memory. Microprocessor 12 is a processing unit capable of processing data.

In particular embodiments, microprocessor 12 can run corresponding programs by executing corresponding program code stored in corresponding program code areas of code memory 11. For example, microprocessor 12 can run a bootloader program by executing bootloader program code stored in the bootloader program code area. In another example, microprocessor 12 can run an application program by executing application program code stored in an application program code area. Optionally, microprocessor 12 can be a microprocessor that itself lacks program code area jump capability, such as a microprocessor based on a Cortex-M0 core. Address remapping circuit 13 can be disposed between code memory 11 and microprocessor 12. In particular embodiments, address remapping circuit 13 can assist microprocessor 12 in program code area jump while reading required code content from code memory 11 for microprocessor 12. In particular embodiments, the hardware online upgrade system may also include bus 14. Address remapping circuit 13 can connect to code memory 11 via bus 14, thereby achieving data interaction between each other.

In particular embodiments, address remapping circuit 13 assisting microprocessor 12 in program code area jump may refer to assisting the microprocessor in jumping from the currently executing program code area to another program code area when the microprocessor wishes to perform code area jump and actively triggers a system reset. It may also refer to assisting the microprocessor in jumping back to the program code area being executed before a system interrupt occurred when the microprocessor experiences a system interrupt due to system influence.

For ease of understanding, the following description will take address remapping circuit 13 assisting microprocessor 12 in jumping to a target program code area as an example. The target program code area can be a bootloader program code area or an application program code area. For the first case above, the target program code area may refer to the program code area the microprocessor wishes to jump to. When microprocessor 12 needs to jump from the current program code area being executed to a target program code area, microprocessor 12 can actively trigger the system to reset. The reset of the system causes the instruction address of microprocessor 12 to be reset to point to the interrupt vector table of the initial program code area.

Upon detecting that the current instruction address of microprocessor 12 points to the interrupt vector table of the initial program code area, address remapping circuit 13 can perform address offset on the current instruction address according to a target offset address, and read a target reset vector from code memory 11 according to the offset instruction address. Then, after obtaining the target reset vector, microprocessor 12 can jump to the target program code area according to the target reset vector to execute a corresponding hardware online upgrade process by running the target program. The target offset address can be the storage address offset between the interrupt vector table of the target program code area and the interrupt vector table of the initial program code area.

For the second case above, the target program code area may refer to the program code area being executed by microprocessor before the system interrupt occurred. Further, after the microprocessor occurs the system interrupt due to system influence, the system interrupt also causes the instruction address of microprocessor 12 to be reset to point to the interrupt vector table of the initial program code area. Upon detecting that the current instruction address of microprocessor 12 points to the interrupt vector table of the initial program code area, address remapping circuit 13 can perform address offset on the current instruction address according to a target offset address, and read a target reset vector from code memory 11 according to the offset instruction address. Then, after obtaining the target reset vector, microprocessor 12 can jump to the target program code area according to the target reset vector to execute a corresponding hardware online upgrade process by running the target program. The target offset address can be the storage address offset between the interrupt vector table of the target program code area and the interrupt vector table of the initial program code area.

The storage address of the interrupt vector table of the initial program code area is usually the start address of code memory 11, e.g., address 0x00000000, and the interrupt vector table is usually located at the beginning of a code area thereof. Thus, the target offset address can also be understood as the start address of the target program code area. In particular embodiments, upon detecting that the current instruction address of microprocessor 12 does not point to the interrupt vector table of the initial program code area, address remapping circuit 13 can directly read required code content from code memory 11 for microprocessor 12 according to the current instruction address.

The initial program code area can refer to the program code area that the system enters by default after the system is abnormal and is recovered. For example, the abnormality of the system can include the reset of the system triggered by the microprocessor and the interrupt of the system caused by the microprocessor being affected by the system. In prior art, due to lacking the capability to jump to the program code area, the microprocessor enters this initial program code area every time after the system is abnormal and is recovered, which also prevents microprocessors from operating a multi-program code area storage architecture. As compared to other approaches, particular embodiments assist microprocessor 12 in performing program code area jump by providing address remapping circuit 13, and can enable the microprocessor to achieve program code area jump without the prerequisite of having the ability to jump between program code regions itself, thereby supporting deployment and operation of a multi-program code area storage architecture, and further supporting hardware online upgrade.

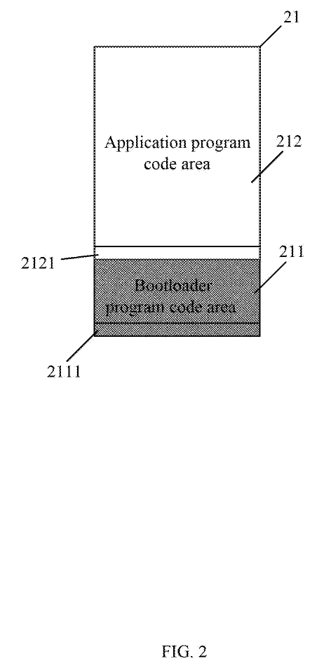

Referring now to FIG. 2, shown is a schematic diagram of an example code memory in accordance with embodiments of the present invention. In this particular example, code memory 21 can include bootloader program code area 211 and an application program code area 212. Here, for ease of distinction, bootloader program code area 211 is marked with shading in FIG. 2. Although FIG. 2 only shows a certain number of application program code areas, it does not limit the set number of application program code areas. For example, when storage space permits, the code memory can also be set to include multiple application program code areas.

In the code memory of FIG. 2, the initial program code area is set at the beginning of code memory 21, that is, the initial program code area is set as bootloader program code area 211. However, in some applications, the initial program code area can also be set as a corresponding application program code area. Bootloader program code area 211 and application program code area 212 can store program codes of corresponding programs, respectively. Further, each program code area can include its own interrupt vector table (as shown by interrupt vector table 2111 of bootloader program code area 211 and interrupt vector table 2121 of application program code area 212). The interrupt vector table can store reset vectors. The reset vector can indicate the code execution address for the microprocessor after recovery. To facilitate further understanding of the operation logic of the multi-program code area storage architecture during system power-up and hardware online upgrade processes, the code memory in FIG. 2 is used as an example for explanation.

In particular embodiments, upon system power-up, the microprocessor can first jump to bootloader program code area 211 and perform initialization of related hardware by running the bootloader program. Then, the microprocessor can jump to application program code area 212 and execute corresponding business logic by running the application program, thereby providing services or functions externally. Thus, the microprocessor can enter a normal operating state after system power-up based on the multi-program code area storage architecture.

During hardware online upgrade, the instructions executed by the microprocessor need to jump between different program code areas. In one embodiment, the device powers up, the bootloader program starts and completes hardware initialization. When an FOTA update requirement is detected, the microprocessor causes the bootloader program to establish a connection with a server, downloads the package for the new version of the application program to the old version application program code storage area, and then performs integrity and legality verification on the new version upgrade package. After the verification passes, the execution instruction of the microprocessor can jump from bootloader program code area 211 to application program code area 212 to run the new version application program. In another embodiment, when the microprocessor is running a program in the application program code area and wants to upgrade the application program code area code (FOTA), the microprocessor can first run the old version application program in application program code area 212 to perform pre-update confirmation.

After completing the update confirmation, the microprocessor can jump to bootloader program code area 211, causing the bootloader program to establish a connection with the server, download the package for the new version of the application program to the old version application program code storage area, and then perform integrity and legality verification on the new version upgrade package. After the verification passes, the microprocessor can jump to application program code area 212 and perform post-update confirmation by running the new version application program. Thus, the microprocessor can complete the hardware online upgrade process based on the multi-program code area storage architecture. The operation logic of the multi-program code area storage architecture during system power-up and hardware online upgrade processes given above is merely to illustrate the roles it plays. In some applications, the specific operation logic of the multi-program code area storage architecture during system power-up and hardware online upgrade processes can be set and adjusted accordingly.

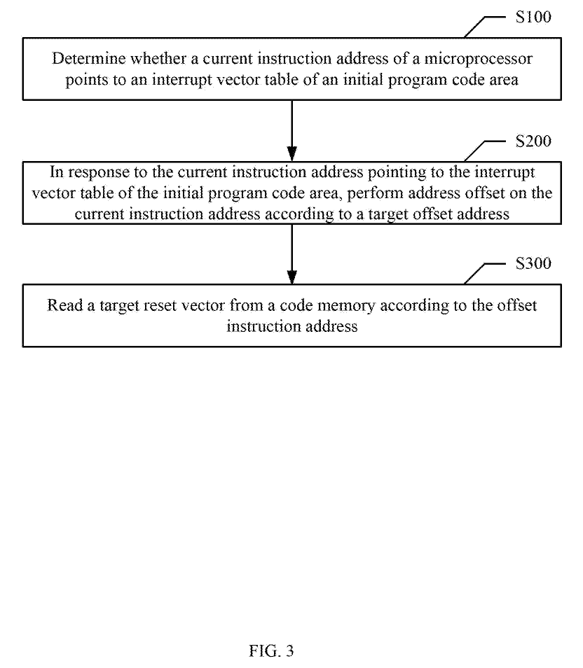

Referring now to FIG. 3, shown is a flowchart of an example address remapping method in accordance with embodiments of the present invention. The execution subject of the address remapping method can be the address remapping circuit of the above embodiment. The address remapping circuit can implement the address remapping method via hardware, software, or a combination thereof. By implementing the address remapping method, the address remapping circuit can assist a microprocessor in program code area jump. In this particular example 3, the address remapping method may include the following steps. At S100, determining whether a current instruction address of a microprocessor points to an interrupt vector table of an initial program code area.

Whether actively triggering a system reset or experiencing a system interrupt, the microprocessor generates a corresponding instruction address according to an interrupt number after recovery. However, due to lacking ability to jump code, the instruction address generated by the microprocessor may only point to the interrupt vector table of the initial program code area, not the interrupt vector table of a target program code area. For example, regardless of whether the target program code area is a bootloader program code area or an application program code area, the microprocessor only generates the instruction address pointing to the interrupt vector table of the initial program code area according to the interrupt number. This example performs address offset on the instruction address generated after recovery to ensure the microprocessor correctly jumps to the target program code area after recovery. In this step, this example can continuously determine whether the current instruction address of the microprocessor points to the interrupt vector table of the initial program code area to confirm whether address offset is needed for the current instruction address. The target program code area can be the code area the microprocessor needs to jump to.

Optionally, the target program code area can be a bootloader program code area or an application program code area, which is not limited in this application. When the microprocessor actively triggers a system reset because it wishes to perform a code area jump, the target program code area may refer to the program code area the microprocessor wishes to jump to. When the microprocessor experiences a system interrupt due to system influence, the target program code area may refer to the program code area the microprocessor was executing before the system interrupt occurred.

In particular embodiments, in S100, the current instruction address can be compared with a preset address range to determine whether the current instruction address points to the interrupt vector table of the initial program code area. The preset address range can characterize the memory size of the interrupt vector table of the initial program code area. Here, the start address of the interrupt vector table of the initial program code area is usually the start address of the code memory, e.g., address 0x00000000. Under this premise, after setting the memory size of the interrupt vector table of each program code area equal to the memory size of the interrupt vector table of the initial program code area, this embodiment can confirm that the current instruction address points to the interrupt vector table of the initial program code area upon detecting that the current instruction address is less than or equal to the preset address range. Particular embodiments can confirm that the current instruction address does not point to the interrupt vector table of the initial program code area upon detecting that the current instruction address is greater than the preset address range. Particular embodiments may only need to ensure the memory sizes of the interrupt vector tables of each program code area are equal to the memory size of the interrupt vector table of the initial program code area, and does not limit the specific reset vector content stored in each program code area. That is, the specific reset vector content stored in each program code area can be the same or different.

At S200, in response to the current instruction address pointing to the interrupt vector table of the initial program code area, perform address offset on the current instruction address according to a target offset address. In particular embodiments, when the current instruction address of the microprocessor is determined to point to the interrupt vector table of the initial program code area, the address offset can be confirmed to be needed for the current instruction address. Then, address offset can be performed on the current instruction address according to the target offset address. Typically, the storage address of the interrupt vector table of the initial program code area is usually the start address of the code memory, e.g., address 0x00000000, and the interrupt vector table is usually located at the beginning of its code area. Thus, the target offset address can also be understood as the start address of the target program code area.

In particular embodiments, before performing address offset on the current instruction address according to the target offset address, particular embodiments can first select a first offset value or a second offset value as the target offset address for output according to a condition value, thereby obtaining the target offset address. Further, the condition value can include a first numerical value. The condition value can be reset to the first numerical value when the system is abnormal. The first numerical value can instruct selection of the first offset value as the target offset address for output.

The first offset value can be set as the start address of the target program code area when the system is abnormal. The first offset value can be unaffected by the abnormality of the system. Further, before the system is abnormal, the first offset value can be set as the start address of the target program code area under the instruction of the microprocessor. When the system is abnormal, the condition value is reset to the first numerical value, and the first offset value can be selected, e.g., the pre-set start address of the target program code area, as the target offset address for output according to the first numerical value. Then, particular embodiments can perform address offset on the current instruction address according to this target offset address.

When implementing the above process via hardware, the condition value can be set as the value stored in a condition register. This condition register can be a register whose internally stored value can be read and modified, and can reset its internally stored value after the system is abnormal. For example, this condition register can be set to reset its internally stored value to the first numerical value after the system is abnormal. The first offset value can be set as the value stored in a first address register. This first address register can be a register whose internally stored value can be read and modified, and whose internally stored value is unaffected by the abnormality of the system. In particular embodiments, the abnormality of the system may refer to a system reset actively triggered by the microprocessor, or a system interrupt experienced by the microprocessor due to system influence, but excludes system power-up.

Further, the condition value can also include a second numerical value. The condition value can be set to the second numerical value when the system is not abnormal. The second numerical value can instruct selection of the second offset value as the target offset address for output. The second offset value can be set as the start address of the code area currently being executed by the microprocessor when the system is not abnormal. The second offset value can be reset to an initial address upon the abnormality of the system. Further, after the microprocessor recovers, the second offset value can set to the start address of the code area currently being executed by the microprocessor under the microprocessor's instruction. Also, this embodiment can set the condition value to the second numerical value under the microprocessor's instruction. Then, the second offset value can be selected, e.g., the start address of the code area currently being executed by the microprocessor, as the target offset address for output according to the second numerical value. Thus, particular embodiments can avoid timing confusion while not affecting the microprocessor's normal access to data within the interrupt vector table.

In particular embodiments, when implementing the above process via hardware, the second offset value can be set as the value stored in a second address register. This second address register can be a register whose internally stored value can be read and modified, and can reset its internally stored value after the system is abnormal and is powered-up. Further, upon system power-up, the microprocessor usually needs to first jump to the bootloader program code area and perform initialization of related hardware by running the bootloader program, and then jump to an application program code area to provide services to users by running an application program. When the initial program code area is set as the bootloader program code area, to enable the microprocessor to first jump to the initial program code area after system power-up, the first offset value can be reset to 0x00000000, e.g., the start address of the initial program code area, upon system power-up. The condition value can be reset to the first numerical value upon system power-up.

When implementing the above process via hardware, the first address register also needs to be able to reset its internally stored value after system power-up occurs. For example, the first address register can be set to reset its internally stored value to 0x00000000, e.g., the start address of the initial program code area, upon system power-up. The condition register also needs to be able to reset its internally stored value after system power-up occurs. For example, the first address register can be set to reset its internally stored value to the first numerical value upon system power-up.

In particular embodiments, to ensure that after a system interrupt occurs, the microprocessor can correctly jump back to the program code area being executing before the system interrupt occurs, the first offset value can be set to remain unchanged when a system reset has not occurred, e.g., keep the first offset value unchanged as the start address of the current code area being executed by the microprocessor when the microprocessor has not actively triggered a reset. Thus, when the microprocessor experiences a system interrupt due to system influence, the condition value is reset to the first numerical value. The first offset value can be selected, e.g., the start address of the program code area being executing by the microprocessor before the system interrupt occurs, as the target offset address for output according to the first numerical value. Then, particular embodiments can perform address offset on the current instruction address according to this target offset address.

At S300, a target reset vector can be read from a code memory according to the offset instruction address. In particular embodiments, after performing address offset on the current instruction address, the target reset vector can be read from the code memory according to the offset instruction address and he target reset vector can be send to the microprocessor, so that the microprocessor can jump to the target program code area according to the target reset vector.

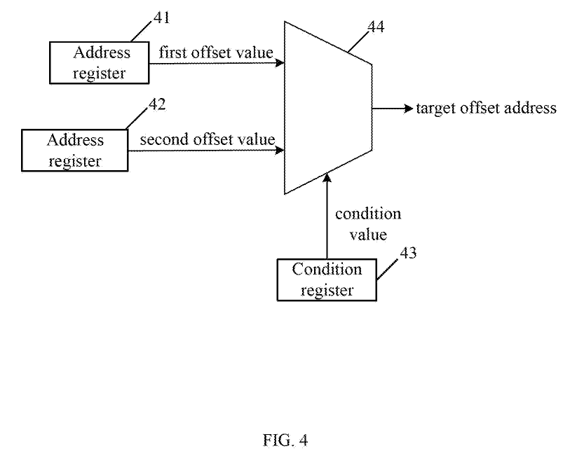

Referring now to FIG. 4, shown is a schematic diagram of an example offset address output circuit in accordance with embodiments of the present invention. The offset address output circuit shown in this example can be a hardware circuit for implementing the above target offset address determination process. In this particular example, the offset address output circuit can include address register 41, address register 42, condition register 43, and selector 44.

Address register 41 is a register for storing a first offset value. First address register 41 may be a register whose internally stored value can be read and modified, and whose internally stored value is unaffected by the abnormality of the system, but can reset its internally stored value after the system is powered-up. Address register 42 is a register for storing a second offset value. Second address register 42 may be a register whose internally stored value can be read and modified, and can reset its internally stored value after the system is abnormal and is powered-up. Condition register 43 is a register for storing a condition value. Condition register 43 may be a register whose internally stored value can be read and modified, and can reset its internally stored value after the system is abnormal and is powered-up. Selector 44 can select the first offset value stored in address register 41 or the second offset value stored in address register 42 as the target offset address for output according to the condition value stored in condition register 43.

In one embodiment, before the system is abnormal, the value stored in address register 41 can first be modified by the microprocessor to the start address of the target program code area. When the system is abnormal, condition register 43 can reset its internally stored value to the first numerical value. Selector 44 can select the first offset value stored in address register 41 as the target offset address for output according to the first numerical value. Thus, this embodiment can ensure that the microprocessor jumps to the target program code area after the system is abnormal and is recovered.

When the system is operating normally, the value stored in address register 42 can be modified by the microprocessor to the start address of the code area being currently executed. The value stored in condition register 43 can be modified by the microprocessor to the second numerical value. Selector 44 can select the second offset value stored in address register 42 as the target offset address for output according to the second numerical value. Thus, this embodiment can avoid timing confusion while not affecting the microprocessor's normal access to data within the interrupt vector table.

Upon system power-up, address register 41 can reset its internally stored value to the start address of the initial program code area, and condition register 43 can reset its internally stored value to the first numerical value. Selector 44 can select the first offset value stored in address register 41 as the target offset address for output according to the first numerical value. Thus, particular embodiments can ensure that when the initial program code area is the bootloader program code area, the microprocessor can first jump to the bootloader program code area after power-up to initialize related hardware by running the bootloader program.

In particular embodiments, the internally stored value of address register 41 can also be set to remain unchanged as the start address of the code area currently being executed by the microprocessor when a system reset is not occurred, e.g., when the microprocessor is not actively triggered a reset. Thus, this embodiment can ensure that after the system interrupt occurs, the microprocessor can correctly jump back to the program code area being executed before the system interrupt occurs.

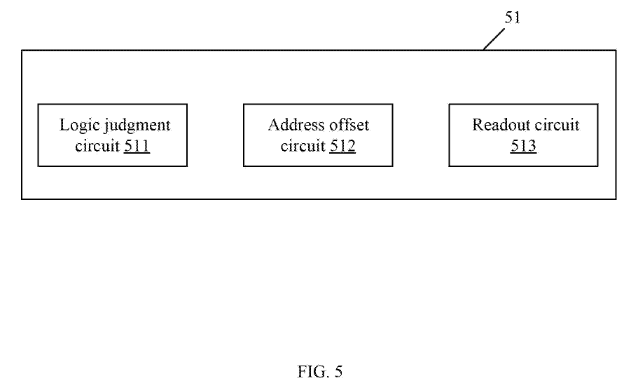

Referring now to FIG. 5, shown is a schematic diagram of an example address remapping circuit in accordance with embodiments of the present invention. In this particular example, address remapping circuit 51 can include logic judgment circuit 511, address offset circuit 512, and readout circuit 513. Logic judgment circuit 511 can determine whether a current instruction address of a microprocessor points to an interrupt vector table of an initial program code area.

In particular embodiments, the logic judgment circuit can determine whether the current instruction address of the microprocessor points to the interrupt vector table of the initial program code area by comparing the current instruction address with a preset address range. The preset address range can characterize the memory size of the interrupt vector table of the initial program code area. Upon detecting that the current instruction address is less than or equal to the preset address range, logic judgment circuit 511 can confirm that the current instruction address points to the interrupt vector table of the initial program code area. Upon detecting that the current instruction address is greater than the preset address range, logic judgment circuit 511 can confirm that the current instruction address does not point to the interrupt vector table of the initial program code area.

Address offset circuit 512 can, in response to the current instruction address pointing to the interrupt vector table of the initial program code area, perform address offset on the current instruction address according to a target offset address. The target offset address is the start address of a target program code area. Readout circuit 513 can read a target reset vector from a code memory according to the offset instruction address. In one embodiment, the address remapping circuit can also include an offset address output circuit. This offset address output circuit can select a first offset value or a second offset value as the target offset address for output according to a condition value.

In one embodiment, the condition value can include a first numerical value. The condition value can be reset to the first numerical value when the system is abnormal. The first numerical value can instruct selection of the first offset value as the target offset address for output. The first offset value can be set as the start address of the target program code area when the system is abnormal. The first offset value can be unaffected by the abnormality of the system.

The condition value can also include a second numerical value. The condition value can be set to the second numerical value when the system is not abnormal. The second numerical value can instruct selection of the second offset value as the target offset address for output. The second offset value can be set as the start address of the code area currently being executed by the microprocessor when the system is not abnormal. The second offset value can be reset to an initial address upon the abnormality of the system.

When the initial program code area is set as the bootloader program code area, to enable the microprocessor to first jump to the initial program code area upon system power-up, the first offset value can be reset to the start address of the initial program code area upon system power-up. To ensure that after a system interrupt occurs, the microprocessor can correctly jump back to the program code area being executed before the system interrupt occurs, the first offset value can remain unchanged when the system reset is not occurred (e.g., when the microprocessor is not actively triggered a reset).

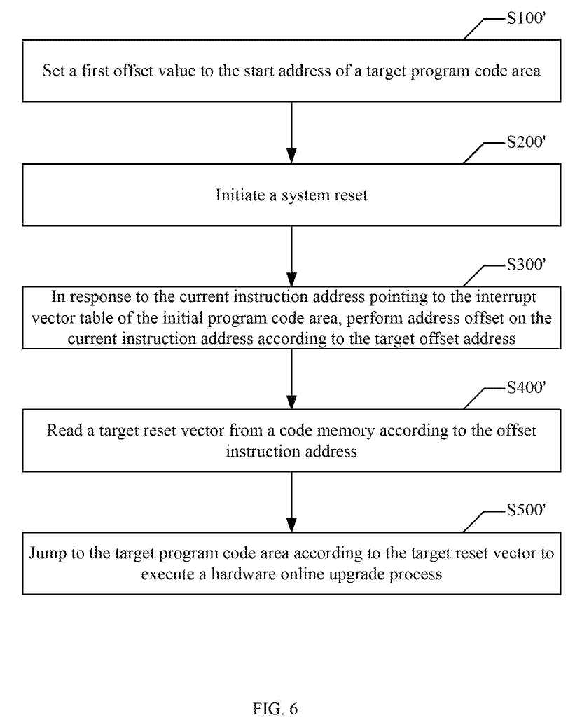

Referring now to FIG. 6, shown is a flowchart of an example hardware online upgrade method in accordance with embodiments of the present invention. The execution subject of the address remapping method can be the hardware upgrade system in the above embodiment. For example, the steps of the hardware online upgrade method can be executed by the microprocessor and the address remapping circuit in the hardware upgrade system, respectively. In this particular example, the hardware online upgrade method may include the following steps:

At S100', a first offset value can be set to the start address of a target program code area. In one embodiment, when needing to jump from the currently executing program code area to a target program code area, the microprocessor can first set the first offset value of the address remapping circuit to the start address of the target program code area. Optionally, before setting the first offset value to the start address of the target program code area, the microprocessor can first perform a security verification, and then, upon detecting that the security verification passes, set the first offset value to the start address of the target program code area.

Optionally, before setting the first offset value to the start address of the target program code area, the microprocessor can first disable interrupts except for non-maskable interrupts and hard fault interrupts to ensure stability of code execution during the process of the instruction address jumping to the target program code area. At S200', a system reset can be initiated.

In one embodiment, after setting the first offset value to the start address of the target program code area, the microprocessor can initiate a system reset. During the system reset, the current instruction address is configured to point to the interrupt vector table of the initial program code area, and the condition value is reset to a first numerical value. The first numerical value can instruct selection of the first offset value as the target offset address for output.

At S300', in response to the current instruction address pointing to the interrupt vector table of the initial program code area, perform address offset on the current instruction address according to the target offset address. In one embodiment, upon detecting that the current instruction address of the microprocessor points to the interrupt vector table of the initial program code area, the address remapping circuit can perform address offset on the current instruction address according to the target offset address.

At S400', a target reset vector can be read from a code memory according to the offset instruction address. In one embodiment, after performing address offset on the current instruction address, the address remapping circuit can read the target reset vector from the code memory according to the offset instruction address. At S500', a jump to the target program code area can be performed according to the target reset vector to execute a hardware online upgrade process. In one embodiment, after the address remapping circuit reads the target reset vector, the microprocessor can jump to the target program code area according to the target reset vector to execute the hardware online upgrade process.

Optionally, before S100', when the system is operating normally, the microprocessor can also assign the first offset value to a second offset value and update the condition value to a second numerical value. The first offset value can be maintained as the start address of the program code area being currently executed when the microprocessor is not actively triggered a reset. That is, it is equivalent to the microprocessor setting the second offset value to the start address of the program code area being currently executed. The second numerical value can instruct the address remapping circuit to select the second offset value as the target offset address for output. Thus, this embodiment can avoid timing confusion while not affecting the microprocessor's normal access to data within the interrupt vector table.

Optionally, when a system interrupt occurs, the current instruction address can be configured to point to the interrupt vector table of the initial program code area. In this scenario, the address remapping circuit can also, upon detecting that the current instruction address of the microprocessor points to the interrupt vector table of the initial program code area, perform address offset on the current instruction address according to the target offset address, thereby causing the current instruction address to jump to the target program code area. Of course, when a system interrupt occurs, the target program code area is the code area being executed before the system interrupt occurred, and the target offset address is the start address of that target program code area.

The following takes an FOTA architecture with a total code memory size of 128KB, a bootloader program code area of 32KB with start address set to 0x00000000, an application program code area of 96KB with start address set to 0x00080000 as one particular example to describe the FOTA and the process of instruction jump between the bootloader program code area and the application program code area.

Upon system power-up, the first offset value and the second offset value are both reset and set to the start address of the bootloader program code area, e.g., 0x00000000. It should be noted that since the initial program code area is set as the bootloader program code area, this can also be understood as both the first offset value and the second offset value being reset and set to the start address of the initial program code area, e.g., 0x00000000. Also, the internal value of the condition register is reset to the first numerical value. The selector selects the first offset value stored in the first address register as the target offset address for output according to the first numerical value. At this point, the current instruction address of the microprocessor may point to the initial program code area (e.g., the interrupt vector table of the bootloader program code area) both before and after offset. Thus, the microprocessor's instruction can execute in the bootloader program code area, achieving bootloader program code area startup and hardware initialization.

When an FOTA update requirement is detected, the bootloader program code area establishes a connection with a server, downloads a new package to the application program code area, and then performs integrity and legality verification on the new package. After the verification passes, it needs to jump from the bootloader program code to the application program code area. The jump process is shown as follows. The interrupts other than non-maskable interrupts and hard fault interrupts can be disabled to ensure stability of code execution during the process of the instruction address jumping to the target program code area.

The first offset value can be assigned to the second offset value. Since the first offset value is 0x00000000, the second offset value becomes 0x00000000, and the condition value can be updated to the second numerical value, thereby selecting the second offset value as the target offset address for output according to the second numerical value. The current instruction address continues to point to the initial program code area, so the program continues to run normally in the bootloader program code area. The first offset value can be set to the start address of the target program code area. At this point, the target program code area is the application program code area, so set the first offset value to 0x00008000.

A system reset can be initiated. During the system reset, the current instruction address is configured to point to the interrupt vector table of the initial program code area, the condition value is reset to the first numerical value. The first numerical value can instruct selection of the first offset value 0x00008000 as the target offset address for output. The current instruction address begins to point to the interrupt vector table of the application program code area, so the program runs in the application program code area.

When the instruction is running in the application program code area, if a system interrupt occurs, the condition value is reset to the first numerical value, and the current instruction address is set to point to the initial program code area (now the interrupt vector table of the bootloader program code area). In response to the current instruction address pointing to the interrupt vector table of the initial program code area, the address offset can be performed on the current instruction address according to the target offset address; the first numerical value can instruct selection of the first offset value 0x00008000 as the target offset address for output, thereby offsetting the current instruction address according to the first offset value 0x00008000, and causing the program to continue running in the application program code area before the interrupt occurred.

When the instruction is running in the application program code area and an upgrade (FOTA) of the application program code area code is desired, after completing upgrade confirmation in the application program (e.g., identity authentication of the host initiating the upgrade), then the bootloader program code area jumped to may be executed by the upgrade process. The jump process is shown as follows. Interrupts other than non-maskable interrupts and hard fault interrupts can be disabled to ensure stability of code execution during the process of the instruction address jumping to the target program code area.

The first offset value can be assigned to the second offset value. Since the first offset value is only reset upon system power-up, the first offset value remains 0x00008000. After assignment, the second offset value remains 0x00008000, and the condition value can be updated to the second numerical value, thereby selecting the second offset value 0x00008000 as the target offset address for output according to the second numerical value. The current instruction address continues to point to the application program code area, so the program continues to run normally in the application program code area.

The first offset value can be set to the start address of the target program code area. At this point, the target program code area is the bootloader program code area, so as to set the first offset value to 0x00000000, and initiate a system reset. During the system reset, the current instruction address is configured to point to the interrupt vector table of the initial program code area, the condition value is reset to the first numerical value. The first numerical value can instruct selection of the first offset value 0x00000000 as the target offset address for output. The current instruction address begins to point to the interrupt vector table of the bootloader program code area, so the program runs in the bootloader program code area.

When the instruction is running in the bootloader program code area, if a system interrupt occurs, the condition value is reset to the first numerical value, and the current instruction address is set to point to the initial program code area (now the interrupt vector table of the bootloader program code area). In response to the current instruction address pointing to the interrupt vector table of the initial program code area, the address offset can be performed on the current instruction address according to the target offset address; and the first numerical value can instruct selection of the first offset value 0x00000000 as the target offset address for output, thereby offsetting the current instruction address according to the first offset value 0x00000000, e.g., no offset is performed on the current instruction address, and causing the program to continue running in the bootloader program code area before the interrupt occurred.

The address remapping circuit of particular embodiments can detect whether a current instruction address of a microprocessor points to an interrupt vector table of an initial program code area, and upon detecting that the current instruction address of the microprocessor points to the interrupt vector table of the initial program code area, the address offset can be performed on the current instruction address according to a target offset address, and a target reset vector can be read from a code memory according to the offset instruction address. The target offset address is a start address of a target program code area. Thus, by providing the address remapping circuit to assist the microprocessor in program code area jump, embodiments of the present invention can enable the microprocessor to achieve program code area jump without the prerequisite of having the ability to jump between program code regions itself, thereby supporting deployment and operation of a multi-program code area storage architecture, and further supporting hardware online upgrade.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. An address remapping circuit, comprising:
a) a logic judgment circuit configured to determine whether a current instruction address of a microprocessor points to an interrupt vector table of an initial program code area;
b) an address offset circuit configured to, in response to the current instruction address pointing to the interrupt vector table of the initial program code area, perform address offset on the current instruction address according to a target offset address, wherein the target offset address is a start address of a target program code area; and
c) a readout circuit configured to read a target reset vector from a code memory according to the offset instruction address.

2. The address remapping circuit of claim 1, wherein the logic judgment circuit is configured to compare the current instruction address with a preset address range to determine whether the current instruction address points to the interrupt vector table of the initial program code area, and the preset address range is used to characterize a memory size of the interrupt vector table of the initial program code area.

3. The address remapping circuit of claim 1, wherein the address remapping circuit is disposed between a microprocessor and the code memory, the code memory comprises a plurality of program code areas, and each program code area comprises the interrupt vector table.

4. The address remapping circuit of claim 3, further comprising an offset address output circuit, configured to select a first offset value or a second offset value as the target offset address for output according to a condition value, wherein the condition value comprises a first numerical value, the condition value is reset to the first numerical value when a system is abnormal, and the first numerical value is used to instruct selection of the first offset value as the target offset address for output.

5. The address remapping circuit of claim 4, wherein the first offset value is set to the start address of the target program code area before the system is abnormal, the first offset value is unaffected by the abnormality of the system, and the abnormality of the system comprises a system interrupt and/or a system reset.

6. The address remapping circuit of claim 4, wherein the condition value further comprises a second numerical value, the condition value is set to the second numerical value when the system is normal, and the second numerical value is used to instruct selection of the second offset value as the target offset address for output.

7. The address remapping circuit of claim 6, wherein the second offset value is set to a start address of a current code area being executed by the microprocessor when the system is normal, and the second offset value is reset to an initial address when the system is abnormal.

8. The address remapping circuit of claim 5, wherein the first offset value is reset to a start address of the initial program code area when the system is powered-up.

9. The address remapping circuit of claim 5, wherein the first offset value remains unchanged when the system is not be triggered to reset.

10. An address remapping method for an address remapping circuit, the method comprising:
a) determining whether a current instruction address of a microprocessor points to an interrupt vector table of an initial program code area;
b) in response to the current instruction address pointing to the interrupt vector table of the initial program code area, performing address offset on the current instruction address according to a target offset address, wherein the target offset address is a start address of a target program code area; and
c) reading a target reset vector from a code memory according to the offset instruction address.

11. The method of claim 10, wherein the determining whether the current instruction address of the microprocessor points to the interrupt vector table of the initial program code area comprises comparing the current instruction address against a preset address range to determine whether the current instruction address points to the interrupt vector table of the initial program code area, wherein the preset address range is used to characterize a memory size of the interrupt vector table of the initial program code area.

12. The method of claim 10, wherein the address remapping circuit is disposed between a microprocessor and a code memory, the code memory comprises a plurality of program code areas, and each program code area comprises the interrupt vector table.

13. The method of claim 12, further comprising selecting a first offset value or a second offset value as the target offset address for output according to a condition value, wherein the condition value comprises a first numerical value, the condition value is reset to the first numerical value when a system is abnormal, and the first numerical value is used to instruct selection of the first offset value as the target offset address for output.

14. The method of claim 13, wherein the first offset value is set to the start address of the target program code area before the system is abnormal, the first offset value is unaffected by the abnormality of the system, and the abnormality of the system comprises a system interrupt and/or a system reset.

15. The method of claim 13, wherein the condition value further comprises a second numerical value, the condition value is set to the second numerical value when the system is normal, and the second numerical value is used to instruct selection of the second offset value as the target offset address for output.

16. The method of claim 13, wherein the second offset value is set to a start address of a current code area being executed by the microprocessor when the system is normal, and the second offset value is reset to an initial address when the system is abnormal.

17. The method of claim 14, wherein the first offset value is reset to the start address of the initial program code area when the system is powered-up.

18. The method of claim 14, wherein the first offset value remains unchanged when the system reset has not occurred.

19. A hardware online upgrade method, the method comprising:
a) setting a first offset value to a start address of a target program code area;
b) initiating a reset of a system, wherein during the reset of the system, a current instruction address is configured to point to an interrupt vector table of an initial program code area, a condition value is reset to a first numerical value; and the first numerical value is used to instruct selection of the first offset value as a target offset address for output;
c) in response to the current instruction address pointing to the interrupt vector table of the initial program code area, performing address offset on the current instruction address according to the target offset address;
d) reading a target reset vector from a code memory according to an offset instruction address; and
e) jumping to the target program code area according to the target reset vector to execute a hardware online upgrade process.

20. The method of claim 19, further comprising:
a) when a system occurs an interrupt, pointing to the interrupt vector table of the initial program code area by the current instruction address; in response to the current instruction address pointing to the interrupt vector table of the initial program code area, performing address offset on the current instruction address according to the target offset address, thereby causing the current instruction address to jump to a target program code area; and
b) wherein, when the system occurs the interrupt, the target program code area is the code area being executed before the system occurs the interrupt, and the target offset address is configured as the start address of the target program code area.
